(19) United States
(12) Patent Application Publication
(10) Pub. No.: US 2024/0361769 A1
(43) Pub. Date: Oct. 31, 2024

(54) GNSS Position Offset To Enable On-Ground Matching Of Vehicles and Implements

(71) Applicant: CNH Industrial America LLC, New Holland, PA (US)

(72) Inventor: Christopher Hundley, New Holland, PA (US)

(73) Assignee: CNH Industrial America LLC, New Holland, PA (US)

(21) Appl. No.: 18/141,319

(22) Filed: Apr. 28, 2023

(51) Int. Cl. G05D 1/02; G05D 1/00

(52) U.S. Cl. CPC G05D 1/0278

(57) ABSTRACT

A method for matching on-ground locations between positional reference models. The method may include receiving a first location parameter corresponding to a first positional reference model, where the first location parameter is associated with a position of a data type. In addition, the apparatus may include determining a first translational offset and a second translational offset, where the first translational offset and the second translational offset are associated with a second positional reference model. The apparatus may include applying the first translational offset and the second translational offset to the first location parameter. Moreover, the apparatus may include setting a second location parameter with the first translational offset and the second translational offset applied to the first location parameter, where the second location parameter corresponds to the second positional reference model.

### BACKGROUND

The Global Navigation Satellite System (GNSS) is a critical component of modern navigation systems, providing accurate positioning data for vehicles, aircraft, and other users. GNSS corrections are used to improve the accuracy of GPS positioning by compensating for errors caused by atmospheric effects, satellite clock drift, and other factors. GNSS corrections are also used to translate between positional reference models (e.g., geodetic datums). The accuracy and compatibility of the positional data from GNSS and GNSS corrections depend on the consistency of the positional reference models used by different vehicles and systems. The positional reference model of GNSS corrections is an important parameter that defines the reference frame in which a vehicle or an implement is operating. When two different vehicles are using the same correction source (i.e., positional reference model), they operate in the same reference frame, and there is no shift in the on-ground position between them. In other words, the on-ground positions two vehicles will match given the same set of coordinates, and they will be able to navigate accurately using the same navigation points (e.g., guidance line, boundary, or obstacle data with corresponding coordinates).

However, when the positional reference model, or geodetic datum, of the GNSS corrections is different between vehicles, the on-ground positions of the vehicles or implements will not match. This can lead to significant errors in navigation and guidance, as the systems will be using different reference frames to calculate positions. The magnitude of the difference in on-ground position is dependent on the difference between the geodetic datums, which can range from a few centimeters to a meter or more.

Typical datum translation methods use either a 7 or 14-point Helmert transformation, which involves calculating offsets and rotations in x, y, and z directions, as well as rates for offsets and rotations, and scale. However, this method is only effective when the positional reference models are known and the offset parameters are accurately determined.

Operators of agricultural operations often have mixed fleets of agricultural vehicles (i.e., vehicles from various manufacturers) that utilize GNSS guidance. Because some agricultural vehicles have proprietary correction sources and unique or unknown positional reference models for those sources, it becomes impractical to use the same navigation points (e.g., guidance lines, boundaries, or obstacles) across a mixed fleet of agricultural vehicles. The operator must set the data type parameters with a first vehicle using the first vehicle's proprietary positional reference model to guide the first vehicle, and then set the same data types with a second vehicle using the second vehicle's positional reference model. This causes friction in the agricultural operations and inefficiencies.

### SUMMARY

One embodiment relates to a system. The system may include an agricultural vehicle and a control system having processing circuitry configured to: receive a first location parameter corresponding to a first positional reference model, where the first location parameter is associated with a position of a data type; determine a first translational offset and a second translational offset, where the first translational offset and the second translational offset are associated with a second positional reference model; apply the first translational offset and the second translational offset to the first location parameter; set a second location parameter with the first translational offset and the second translational offset applied to the first location parameter, where the second location parameter corresponds to the second positional reference model. Other embodiments of this aspect include corresponding computer systems, apparatus, and computer programs recorded on one or more computer storage devices, each configured to perform the actions of the methods.

Implementations may include one or more of the following features. In some embodiments, the first location parameter is a coordinate value for the data type. In some embodiments, the first positional reference model is a datum of a global navigation satellite system (GNSS) correction model. In some embodiments, the data type is one of a guidance line, a boundary, or an obstacle.

In some embodiments, where the first translational offset is associated with an East/West correction and the second the second translational offset is associated with a North/South correction. In some embodiments, the control system is further configured to apply a third translational offset and a fourth translational offset to the second location parameter. In some embodiments, the agricultural vehicle is one of a plurality of agricultural vehicles in a fleet, where the plurality of agricultural vehicles have access to the second location parameter. Implementations of the described techniques may include hardware, a method or process, or a computer tangible medium.

Another embodiment relates to a control system including processing circuitry to receive a first location parameter corresponding to a first positional reference model, where the first location parameter is associated with a position of a data type, determine a first translational offset and a second translational offset, where the first translational offset and the second translational offset are associated with a second positional reference model, apply the first translational offset and the second translational offset to the first location parameter, set a second location parameter with the first translational offset and the second translational offset applied to the first location parameter, where the second location parameter corresponds to the second positional reference model. Other embodiments of this aspect include corresponding computer systems, apparatus, and computer programs recorded on one or more computer storage devices, each configured to perform the actions of the methods.

Implementations may include one or more of the following features. In some embodiments, the first location parameter is a coordinate value for the data type. In some embodiments, the first positional reference model is a datum of a global navigation satellite system (GNSS) correction model. In some embodiments, the data type is one of a guidance line, a boundary, or an obstacle. In some embodiments, the first translational offset is associated with an East/West correction and the second the second translational offset is associated with a North/South correction. In some embodiments, the control system is further configured to apply a third translational offset and a fourth translational offset to the second location parameter. In some embodiments, the control system is associated with an agricultural vehicle, where the agricultural vehicle is one of a plurality of agricultural vehicles in a fleet, where the plurality of agricultural vehicles have access to the second location parameter. Implementations of the described techniques may include hardware, a method or process, or a computer tangible medium.

Another embodiment relates to a method. The method includes receiving, by a processor, a first location parameter corresponding to a first positional reference model, where the first location parameter is associated with a position of a data type. The method may also include determining, by the processor, a first translational offset and a second translational offset, where the first translational offset and the second translational offset are associated with a second positional reference model. The method may furthermore include applying, by the processor, the first translational offset and the second translational offset to the first location parameter. The method may in addition include setting, by the processor, a second location parameter with the first translational offset and the second translational offset applied to the first location parameter, where the second location parameter corresponds to the second positional reference model. Other embodiments of this aspect include corresponding computer systems, apparatus, and computer programs recorded on one or more computer storage devices, each configured to perform the actions of the methods.

Implementations may include one or more of the following features. In some embodiments, the first location parameter is a coordinate value for the data type. In some embodiments, the first positional reference model is a datum of a global navigation satellite system (GNSS) correction model. In some embodiments, the data type is one of a guidance line, a boundary, or an obstacle. In some embodiments, the first translational offset is associated with an East/West correction and the second the second translational offset is associated with a North/South correction. In some embodiments, the method may include applying a third translational offset and a fourth translational offset to the second location parameter. Implementations of the described techniques may include hardware, a method or process, or a computer tangible medium.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a driveline of the vehicle of FIG. 1, according to an exemplary embodiment.

FIG. 4 is a schematic block diagram of a control system of the vehicle of FIG. 1, according to an exemplary embodiment.

FIG. 5 is an illustration of an example of two positional reference models, according to an exemplary embodiment.

FIG. 6 is an illustration of an offset calibration method, according to an exemplary embodiment.

FIG. 7 is a schematic block diagram of a fleet of vehicles, including the vehicle of FIG. 1, according to an exemplary embodiment.

FIG. 8 is a flow diagram of a process to translate data type parameters between positional reference models.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, an agricultural vehicle using GNSS is used in an operator's agricultural operations. In the exemplary embodiment, the operator uses a mixed fleet of agricultural vehicles (i.e., vehicles from different manufacturers). The operator's vehicles are from Manufacturer C and Manufacturer D. Manufacturer C sells agricultural vehicles that utilize GNSS navigation. Manufacturer D also sells agricultural vehicles that use GNSS navigation. Manufacturer C has a policy to disseminate information to the public relating to the positional relationship model used in GNSS navigation of its vehicle. Manufacturer D has a policy to not disseminate information to the public relating to the positional relationship model used in GNSS navigation of its vehicles. Further, manufacturer D has a policy to not disseminate information to its customers relating to the positional relationship model used in GNSS navigation of its vehicles.

In using GNSS navigation of the operator's vehicles, the operator sets various data types with associated parameters (collectively, “navigation points”) relating to various guide points on the operator's land. Data types may include, for example, guidance lines, boundaries, objects, hazards, parking locations, planting locations, planned routes, etc. The parameters associated with these various data types include navigational coordinates used by the vehicles during navigation. The operator may set navigation points in a variety of methods. For example, the operator may set navigation points while operating a vehicle using an operator interface communicably coupled to the vehicle. The operator may also set navigation points on a mobile device or on a personal computing device. Likewise, the operator may access navigation points set by others by accessing, by a network, a database hosted on a server. In setting navigation points, the operator must select a positional reference model, or use the default positional reference model associated with the device through which the operator is setting the navigation point.

In the exemplary embodiment, the operator sets various navigation points with the vehicle from Manufacturer D and saves these navigation points to a database (the database either being locally hosted on the vehicle or remotely hosted on a server and accessed by a network). Operator may use these navigation points with all of the vehicles from Manufacturer D because they all use the same positional reference model. However, the operator may not use the navigation points with vehicles from Manufacturer C because the vehicles from Manufacturer C have a different positional reference model that does not align with the Manufacturer D's positional reference model. Because Manufacturer D does not release or disseminate information relating to the positional reference model that Manufacturer D uses, the operator is not able to convert (i.e., offset) the navigation points from the Manufacturer D's positional reference model to Manufacturer C's positional reference model.

To remedy this, the operator may use various embodiments of the current disclosure to offset the navigation points set by the Manufacturer D vehicle in Manufacturer D's positional reference model to align with the Manufacturer C's positional reference model. By doing so, the parameters of the navigation points are translated (i.e., offset) to be used by a vehicle using the Manufacturer C's positional reference model, and consequently allow the operator to use a single set of navigation points with all of the operator's mixed vehicles.

Alternately, the operator may use various embodiments of the current disclosure to offset the GNSS position of the Manufacturer C relative to navigation points set by the Manufacturer D vehicle in Manufacturer D's positional reference model to align with the Manufacturer C's positional reference model. By doing so, the parameters of the GNSS position are translated (i.e., offset) to be used by a vehicle using the Manufacturer C's positional reference model, and consequently allow the operator to use a single set of navigation points with all of the operator's mixed vehicles.

Various embodiments of the present disclosure also apply to an operator who has set navigation points with an unsurveyed base station that the operator has been using for years. The operator would like to move to a satellite-based correction source. Since the base station is unsurveyed, the positional reference model is unknown and therefore known translations cannot be applied to match the unsurveyed navigation points with a vehicle's positional reference model.

Additionally, various embodiments, of the present disclosure may apply to an operator-for-hire. In this embodiment, the operator travels to various farms to perform work with a specialized vehicle (e.g., a sprayer making pesticide applications or a combine harvester operator that harvests the crops for various farmers). Each farm that the operator is working for may have navigation points associated with a unique positional reference model. If the positional reference model is unknown, the operator may not be able to offset the farm's navigation points to align with the vehicle's positional reference model.

In each of the above embodiments, the operator may use various embodiments of the present disclosure to determine an offset to apply to the known navigation points to translate the navigation points from a known positional reference model to an unknown positional reference model, or from an unknown positional reference model to a known positional reference model.

According to an exemplary embodiment, the systems and methods disclosed herein relate to deriving and applying a position offset for a vehicle (or implement) to allow the on-ground position of the vehicle (or implement) to match a desired location without needing to know a positional reference model (e.g., datums) or translation parameters. The offset includes two orthogonal components (e.g., and X offset and a Y offset). In some embodiments, the offset includes a third orthogonal component, such as a height (e.g., a Z offset). In some embodiments, the offsets need not be orthogonal (e.g., using a polar coordination system, a cylindrical coordination system, a spherical coordination system, a skew coordination system, etc.).

When an offset is defined and enabled, the system may automatically apply this offset to all the data types during operation. Alternatively, there may be a mechanism to provide the system with the ability to turn on or off the automatic application of offsets as needed. There may also be a mechanism to automatically detect which offset profile is required based on location or other parameters while the system is operating.

Rather than applying the offset “on the fly” to the position output of the vehicle or implement in real time, the system may apply the desired offsets to one or more navigation points and have the system output revised navigation points that have been translated to reflect the offset information. These new navigation points can be accessed by the vehicle, and the on-ground position of the vehicle or implement may be altered, much in the same way as applying the offset on the fly. However, in an exemplary embodiment, the offset corrections are made on the fly, as described herein.

The system may derive the offset using the following exemplary embodiment of the presently disclosed systems and methods: using a known positional reference model, an operator moves a vehicle to a ground location represented by a navigation point, the navigation point (and associated coordinates) associated with an unknown positional reference model. Once at the ground location, the operator records (in the known positional reference model) a set of coordinates of the vehicle's current position (i.e., the ground position of the navigation point), the recorded set of coordinates being associated with the known positional reference model and stored in a database of the system of the present disclosure.

The operator then moves the vehicle to a second ground location represented by a second navigation point, the second navigation point (and associated coordinates) associated with the unknown positional reference model. While the second ground location can be at any location with reference to the first ground location, in an exemplary embodiment, the second ground location is approximately 90° to the vehicle's direction of travel at the first ground location. Once at the second ground location, the operator records (in the known positional reference model) a second set of coordinates of the vehicle's current position (i.e., the ground position of the second navigation point), the second recorded set of coordinates being associated with the known positional reference model and stored in the database of the system of the present disclosure. This process may be repeated for several ground locations. In an exemplary embodiment, the several ground locations are multiples of 90° from the direction of travel of the vehicle at the first ground location (e.g., 90°, 180°, 270°, etc.).

Now knowing the coordinates of two ground locations in both the known positional reference model and the unknown positional reference model, the system may determine an offset in an X and Y datum (the X and Y being orthogonal) between the known positional reference model and the unknown positional reference model. With this resultant offset, the system may convert coordinates of navigation points between the two positional reference models, whether known or unknown. It should be appreciated, that this method may be used in any combination of positional reference models: known and known, known and unknown, or unknown and unknown. In some embodiments, a third orthogonal datum coordinate is recorded (e.g., in the Z datum).

This offset is stored, and when enabled, the GNSS system (or GNSS correction system) may apply the position offsets to the GNSS position being used for guidance, mapping, and other features on the fly so that the vehicle's on-ground position will be physically moved according to the desired offset. Any data saved or output from the system may also include this position offset, including visual and recorded data for map, as-applied, GNSS position data (such as that which is consumed internally and/or output to 3rd party devices or systems), etc. This allows the on-board and off-board data to match that of the other systems in the fleet that operate on a different positional reference model. This system and method may be used for any number of vehicles and positional reference models.

Multiple configurations can be stored to enable the many different offset profiles to be recalled and used as needed. For example, the user may have a real time kinematic (“RTK”) network with multiple base stations, each requiring a unique offset profile to allow the systems to match on-ground positions during operation.

In other embodiments, the operator may adjust and fine tune the offsets over time. This may include updating offsets based on usage of the offset, recalibrating the offset by repeating the above calibration method for deriving the offset, etc.

The system can also automatically apply the offsets to all data types during operation, and there may be a mechanism to turn this feature on or off as needed. Additionally, the system can automatically detect which offset profile is required based on the vehicle's location or other parameters.

To enable many different offset profiles to be recalled and used as needed, multiple configurations can be stored. The user can also adjust and tune the offset profiles as needed, making the system flexible and adaptable to different situations and environments.

### Overall Vehicle

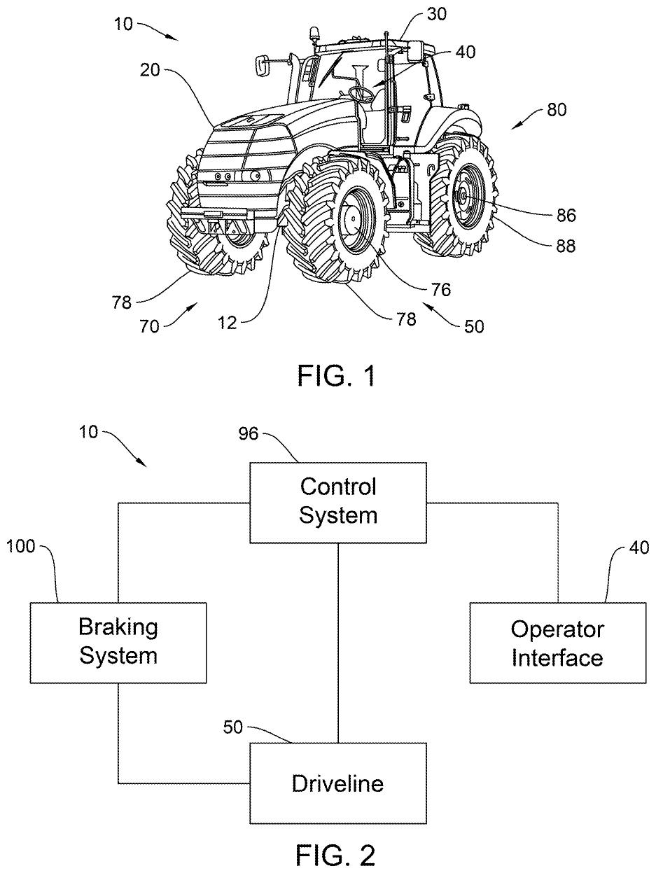

According to the exemplary embodiment shown in FIGS. 1-3, a machine or vehicle, shown as vehicle 10, includes a chassis, shown as frame 12; a body assembly, shown as body 20, coupled to the frame 12 and having an occupant portion or section, shown as cab 30; operator input and output devices, shown as operator interface 40, that are disposed within the cab 30; a drivetrain, shown as driveline 50, coupled to the frame 12 and at least partially disposed under the body 20; a vehicle braking system, shown as braking system 100, coupled to one or more components of the driveline 50 to facilitate selectively braking the one or more components of the driveline 50; and a vehicle control system, shown as control system 200, coupled to the operator interface 40, the driveline 50, and the braking system 100. In other embodiments, the vehicle 10 includes more or fewer components.

The chassis of the vehicle 10 may include a structural frame (e.g., the frame 12) formed from one or more frame members coupled to one another (e.g., as a weldment). Additionally or alternatively, the chassis may include a portion of the driveline 50. By way of example, a component of the driveline 50 (e.g., the transmission 52) may include a housing of sufficient thickness to provide the component with strength to support other components of the vehicle 10.

According to an exemplary embodiment, the vehicle 10 is an off-road machine or vehicle. In some embodiments, the off-road machine or vehicle is an agricultural machine or vehicle such as a tractor, a telehandler, a front loader, a combine harvester, a grape harvester, a forage harvester, a sprayer vehicle, a speedrower, and/or another type of agricultural machine or vehicle. In some embodiments, the off-road machine or vehicle is a construction machine or vehicle such as a skid steer loader, an excavator, a backhoe loader, a wheel loader, a bulldozer, a telehandler, a motor grader, and/or another type of construction machine or vehicle. In some embodiments, the vehicle 10 includes one or more attached implements and/or trailed implements such as a front mounted mower, a rear mounted mower, a trailed mower, a tedder, a rake, a baler, a plough, a cultivator, a rotavator, a tiller, a harvester, and/or another type of attached implement or trailed implement.

According to an exemplary embodiment, the cab 30 is configured to provide seating for an operator (e.g., a driver, etc.) of the vehicle 10. In some embodiments, the cab 30 is configured to provide seating for one or more passengers of the vehicle 10. According to an exemplary embodiment, the operator interface 40 is configured to provide an operator with the ability to control one or more functions of and/or provide commands to the vehicle 10 and the components thereof (e.g., turn on, turn off, drive, turn, brake, engage various operating modes, raise/lower an implement, etc.). The operator interface 40 may include one or more displays and one or more input devices. The one or more displays may be or include a touchscreen, a LCD display, a LED display, a speedometer, gauges, warning lights, etc. The one or more input device may be or include a steering wheel, a joystick, buttons, switches, knobs, levers, an accelerator pedal, a brake pedal, etc.

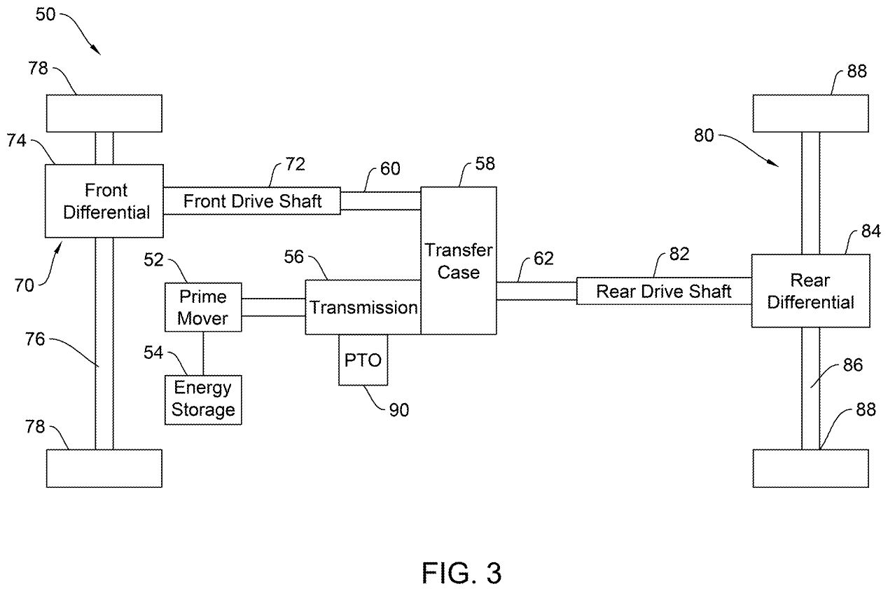

According to an exemplary embodiment, the driveline 50 is configured to propel the vehicle 10. As shown in FIG. 3, the driveline 50 includes a primary driver, shown as prime mover 52, and an energy storage device, shown as energy storage 54. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

As shown in FIG. 3, the driveline 50 includes a transmission device (e.g., a gearbox, a continuous variable transmission (“CVT”), etc.), shown as transmission 56, coupled to the prime mover 52; a power divider, shown as transfer case 58, coupled to the transmission 56; a first tractive assembly, shown as front tractive assembly 70, coupled to a first output of the transfer case 58, shown as front output 60; and a second tractive assembly, shown as rear tractive assembly 80, coupled to a second output of the transfer case 58, shown as rear output 62. According to an exemplary embodiment, the transmission 56 has a variety of configurations (e.g., gear ratios, etc.) and provides different output speeds relative to a mechanical input received thereby from the prime mover 52. In some embodiments (e.g., in electric driveline configurations, in hybrid driveline configurations, etc.), the driveline 50 does not include the transmission 56. In such embodiments, the prime mover 52 may be directly coupled to the transfer case 58. According to an exemplary embodiment, the transfer case 58 is configured to facilitate driving both the front tractive assembly 70 and the rear tractive assembly 80 with the prime mover 52 to facilitate front and rear drive (e.g., an all-wheel-drive vehicle, a four-wheel-drive vehicle, etc.). In some embodiments, the transfer case 58 facilitates selectively engaging rear drive only, front drive only, and both front and rear drive simultaneously. In some embodiments, the transmission 56 and/or the transfer case 58 facilitate selectively disengaging the front tractive assembly 70 and the rear tractive assembly 80 from the prime mover 52 (e.g., to permit free movement of the front tractive assembly 70 and the rear tractive assembly 80 in a neutral mode of operation). In some embodiments, the driveline 50 does not include the transfer case 58. In such embodiments, the prime mover 52 or the transmission 56 may directly drive the front tractive assembly 70 (i.e., a front-wheel-drive vehicle) or the rear tractive assembly 80 (i.e., a rear-wheel-drive vehicle).

As shown in FIGS. 1 and 3, the front tractive assembly 70 includes a first drive shaft, shown as front drive shaft 72, coupled to the front output 60 of the transfer case 58; a first differential, shown as front differential 74, coupled to the front drive shaft 72; a first axle, shown front axle 76, coupled to the front differential 74; and a first pair of tractive elements, shown as front tractive elements 78, coupled to the front axle 76. In some embodiments, the front tractive assembly 70 includes a plurality of front axles 76. In some embodiments, the front tractive assembly 70 does not include the front drive shaft 72 or the front differential 74 (e.g., a rear-wheel-drive vehicle). In some embodiments, the front drive shaft 72 is directly coupled to the transmission 56 (e.g., in a front-wheel-drive vehicle, in embodiments where the driveline 50 does not include the transfer case 58, etc.) or the prime mover 52 (e.g., in a front-wheel-drive vehicle, in embodiments where the driveline 50 does not include the transfer case 58 or the transmission 56, etc.). The front axle 76 may include one or more components.

As shown in FIGS. 1 and 3, the rear tractive assembly 80 includes a second drive shaft, shown as rear drive shaft 82, coupled to the rear output 62 of the transfer case 58; a second differential, shown as rear differential 84, coupled to the rear drive shaft 82; a second axle, shown rear axle 86, coupled to the rear differential 84; and a second pair of tractive elements, shown as rear tractive elements 88, coupled to the rear axle 86. In some embodiments, the rear tractive assembly 80 includes a plurality of rear axles 86. In some embodiments, the rear tractive assembly 80 does not include the rear drive shaft 82 or the rear differential 84 (e.g., a front-wheel-drive vehicle). In some embodiments, the rear drive shaft 82 is directly coupled to the transmission 56 (e.g., in a rear-wheel-drive vehicle, in embodiments where the driveline 50 does not include the transfer case 58, etc.) or the prime mover 52 (e.g., in a rear-wheel-drive vehicle, in embodiments where the driveline 50 does not include the transfer case 58 or the transmission 56, etc.). The rear axle 86 may include one or more components. According to the exemplary embodiment shown in FIG. 1, the front tractive elements 78 and the rear tractive elements 88 are structured as wheels. In other embodiments, the front tractive elements 78 and the rear tractive elements 88 are otherwise structured (e.g., tracks, etc.). In some embodiments, the front tractive elements 78 and the rear tractive elements 88 are both steerable. In other embodiments, only one of the front tractive elements 78 or the rear tractive elements 88 is steerable. In still other embodiments, both the front tractive elements 78 and the rear tractive elements 88 are fixed and not steerable.

In some embodiments, the driveline 50 includes a plurality of prime movers 52. By way of example, the driveline 50 may include a first prime mover 52 that drives the front tractive assembly 70 and a second prime mover 52 that drives the rear tractive assembly 80. By way of another example, the driveline 50 may include a first prime mover 52 that drives a first one of the front tractive elements 78, a second prime mover 52 that drives a second one of the front tractive elements 78, a third prime mover 52 that drives a first one of the rear tractive elements 88, and/or a fourth prime mover 52 that drives a second one of the rear tractive elements 88. By way of still another example, the driveline 50 may include a first prime mover that drives the front tractive assembly 70, a second prime mover 52 that drives a first one of the rear tractive elements 88, and a third prime mover 52 that drives a second one of the rear tractive elements 88. By way of yet another example, the driveline 50 may include a first prime mover that drives the rear tractive assembly 80, a second prime mover 52 that drives a first one of the front tractive elements 78, and a third prime mover 52 that drives a second one of the front tractive elements 78. In such embodiments, the driveline 50 may not include the transmission 56 or the transfer case 58.

As shown in FIG. 3, the driveline 50 includes a power-take-off (“PTO”), shown as PTO 90. While the PTO 90 is shown as being an output of the transmission 56, in other embodiments the PTO 90 may be an output of the prime mover 52, the transmission 56, and/or the transfer case 58. According to an exemplary embodiment, the PTO 90 is configured to facilitate driving an attached implement and/or a trailed implement of the vehicle 10. In some embodiments, the driveline 50 includes a PTO clutch positioned to selectively decouple the driveline 50 from the attached implement and/or the trailed implement of the vehicle 10 (e.g., so that the attached implement and/or the trailed implement is only operated when desired, etc.).

According to an exemplary embodiment, the braking system 100 includes one or more brakes (e.g., disc brakes, drum brakes, in-board brakes, axle brakes, etc.) positioned to facilitate selectively braking (i) one or more components of the driveline 50 and/or (ii) one or more components of a trailed implement. In some embodiments, the one or more brakes include (i) one or more front brakes positioned to facilitate braking one or more components of the front tractive assembly 70 and (ii) one or more rear brakes positioned to facilitate braking one or more components of the rear tractive assembly 80. In some embodiments, the one or more brakes include only the one or more front brakes. In some embodiments, the one or more brakes include only the one or more rear brakes. In some embodiments, the one or more front brakes include two front brakes, one positioned to facilitate braking each of the front tractive elements 78. In some embodiments, the one or more front brakes include at least one front brake positioned to facilitate braking the front axle 76. In some embodiments, the one or more rear brakes include two rear brakes, one positioned to facilitate braking each of the rear tractive elements 88. In some embodiments, the one or more rear brakes include at least one rear brake positioned to facilitate braking the rear axle 86. Accordingly, the braking system 100 may include one or more brakes to facilitate braking the front axle 76, the front tractive elements 78, the rear axle 86, and/or the rear tractive elements 88. In some embodiments, the one or more brakes additionally include one or more trailer brakes of a trailed implement attached to the vehicle 10. The trailer brakes are positioned to facilitate selectively braking one or more axles and/or one more tractive elements (e.g., wheels, etc.) of the trailed implement.

### GNSS Offset Control System

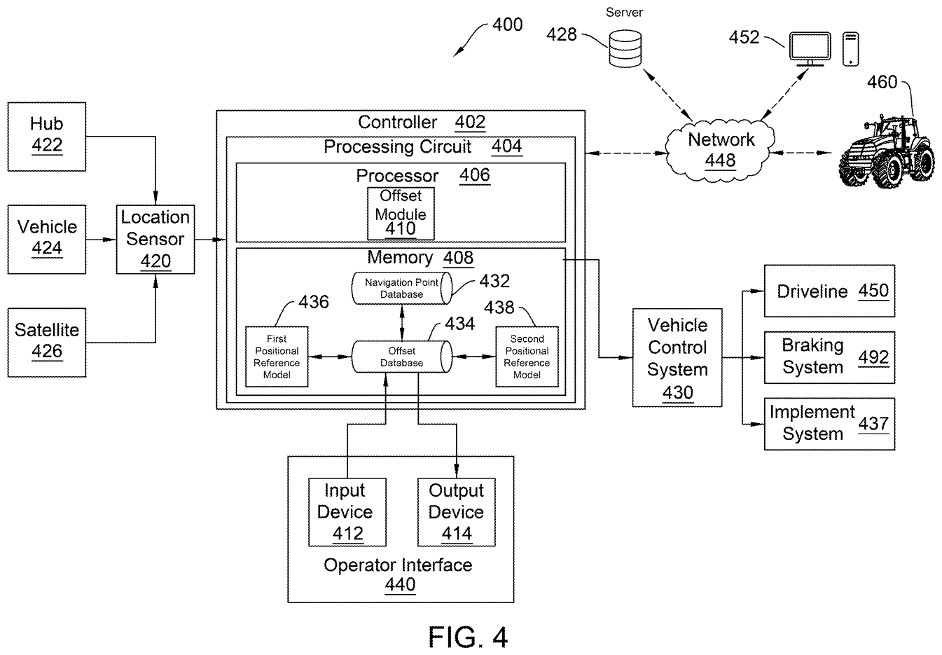

Referring now to FIG. 4, an offset control system 400 for translating between positional reference models is shown. Offset control system 400 may be an exemplary embodiment of a vehicle's control system 96 of FIG. 2. Offset control system 400 may include a controller 402, a location sensor 420, an operator interface 440, a vehicle control system 430, a drive line 450, braking system 492, and implement system 437. The offset control system 400 may also be in communication with a network 448. The offset control system 400 may be in communication with a plurality of fleet vehicles 460 through network 448.

The controller 402 may include a processing circuit 404. The processing circuit 404 including a processor 406, and a memory 408. The processor 406 may include an offset module 410. The memory 408 may include a navigation point database 432, an offset database 434. The memory may also include one or more positional reference models (e.g., first positional reference model 436 and second positional reference model 438). Memory 408 may include instructions, that when executed, cause processor 406 to perform the various steps disclosed herein. In some embodiments, the offset module 410 may be stored in memory 408 and include instructions, that when executed by processor 406, cause the processor to perform certain functionalities of the present disclosure.

Operator Interface 440 may include an input device 412 and an output device 414. Input device 412 may include a steering wheel, pedals, a gearshift, a joystick, a control panel, knobs, dials, touch screens, microphone, global positioning system (GPS) unit, cameras, etc. Output devices may include a touchscreen, an LCD display, an LED display, a speedometer, gauges, warning lights, etc.

The offset module 410 is used to derive and update offsets between positional reference models. For example, location data received by location sensor 420 from one of a hub 422, another vehicle 424, or a satellite 426 is transmitted to the controller. This location data is converted, by the offset module, to coordinates (X and Y) of a first positional reference model 436 of the vehicle. These coordinates can then be translated to coordinates in a second positional reference model 438 using an offset recorded in offset database 434. The offset module 410 may be used to convert navigation points between various positional reference models using the corresponding offset stored in the offset database 434. It should be understood that the navigation point database 432, the offset database 434, the first positional reference model 436, and the second positional reference model 438 may be stored and hosted locally on the memory 408 of the controller 402, or alternatively, stored and hosted remotely on a server 428 in communication with network 448. Likewise, the offset module 410 may be executed by processor 406, or alternatively, stored and hosted remotely on a server 428 (or other server) in communication with network 448.

Offset module 410 may also be configured to receive not only location data from location sensor 420, but location inputs and other location data from the operator interface 440, specifically, input device 412. An operator of the vehicle with which offset control system 400 is equipped may indicate location data (e.g., the current location of the vehicle 10) into input device 412 to be used by offset module 410 in deriving an offset between two positional reference models. Additionally, the operator may input offsets between positional reference models, set navigation points, all of which may be stored in the navigation point database 432, stored in the offset database 434, and/or used by the offset module to derive an offset between two positional reference models.

In some embodiments, offset module 410 may be used to make offset corrections for vehicle 424 on the fly. In such embodiments, the offset module 410 may receive current vehicle 424 location data from the location sensor 420 and apply stored offsets in real time.

Likewise, the operator may input the above-mentioned information through a user computing device 452, the user computing device 452 communicably coupled to network 448.

The location sensor 420 may be in communication with the hub 422, the vehicle 424, or the satellite 426 either wired or wirelessly through the use of various wireless communication protocols, including, but not limited to, Wi-Fi, cellular, Bluetooth, etc.

The hub 422 may be a GNSS hub. A GNSS hub (such as hub 422) may be a device used in farming to receive and distribute GNSS correction signals to multiple agricultural vehicles and equipment in the field. The hub acts as a centralized location for the distribution of these signals, ensuring that all machines in the field receive consistent and accurate positioning information.

The GNSS hub is typically placed in a central location in the farm, such as on a tall pole or on top of a building, to ensure it has a clear view of the sky and can receive the GNSS signals from the satellites. Once the hub receives the signals, it processes them and sends correction signals to the agricultural machines in the field. This helps to improve the accuracy of the positioning data used by the machines for precision agriculture applications.

Using a GNSS hub may have several benefits for farming operations. First, it ensures that all machines in the field receive the same correction signals, reducing errors and improving efficiency. It also allows farmers to use multiple GNSS correction sources, such as different real-time kinematic (“RTK”) networks or satellite systems, by connecting them to the hub. This can help to increase the availability of the correction signals and improve the overall accuracy of the positioning data used by the machines. Traditionally, these corrections sources only work as long as the positional reference model of the machines is known.

In addition, using a GNSS hub can also help to reduce the cost of implementing GNSS technology in farming operations. Instead of having to purchase separate GNSS correction systems for each machine, a single hub can be used to distribute the signals to multiple machines in the field.

The location sensor 420 may receive GNSS correction signals from hub 422 and transmit those correction signals to the processor 406 to be used in the offset module. Likewise, the location data from hub 422 may be transmitted to the memory to be saved in the navigation point database 432 or the offset database 434.

The vehicle 424 may be a vehicle within a fleet of vehicles communicably coupled by network 448 to each other.

The fleet of vehicles (including vehicle 424, and vehicle 460) may be connected by the network 448 through the use of telematics and other communication technologies. Telematics refers to the use of telecommunications and information technology to transmit data and information between machines and devices. By using telematics, the vehicles can be connected together to form a network, allowing them to share information (including current location of the vehicles and offset data) and coordinate their activities.

One way to connect agricultural vehicles is through the use of a dedicated wireless network, such as a Wi-Fi or cellular network. This can allow the vehicle equipped with offset control system 400 to communicate with other fleet vehicles and with a central server, enabling real-time data sharing, coordination of activities/movements, and avoidance of collisions. For example. The vehicle equipped with offset control system 400 may receive location data (in the form of coordinates) from vehicle 424 by location sensor 420. This location data may be converted to coordinates within the same positional reference model as used by the vehicle equipped with the offset control system 400. This may allow both vehicles to work in tandem to complete a task. For example, a combine harvester and a tractor pulling a trailer may need to work in tandem to harvest and store a crop. While the combine harvester is harvesting the crop (e.g., corn) the trailer is positioned beside the harvester, and the grain is unloaded into the trailer using a grain auger or conveyor belt. The trailer is towed beside the harvester as it continues to harvest, allowing the harvester to unload its grain into the trailer without stopping.

As the trailer fills up with grain, it can leave the harvester and be replaced with an empty trailer being pulled by a second tractor, allowing the harvesting process to continue without interruption. The filled trailer is then transported to a storage or processing facility, where the grain can be unloaded and stored or processed further.

This process can be made more efficient and automated if both vehicles (or at least one) is aware of the current location of both vehicles with reference to a single positional reference plane. By using the offset module, the vehicle equipped with the offset control system 400 may locate the second vehicle with reference to the same positional reference model as utilized by the vehicle equipped with the offset control system 400.

Another way to connect agricultural vehicles is through the use of standardized protocols for communication and data exchange. For example, the ISO 11783 standard defines a communication protocol for agricultural machines, allowing them to exchange information about their status, position, and activities. By using this standard, machines from different manufacturers can be connected together in a network, allowing them to share data and work together more efficiently.

In addition, many agricultural machines now come equipped with telematics systems that allow them to communicate with each other and with a central server or control system. These systems can provide real-time data on machine status, location, and activity, allowing farmers to monitor and control their machines remotely.

The location sensor 420 may be in communication with a satellite 426 to receive location data. The location sensor 420 may communicate with the satellite 426 using a GNSS (Global Navigation Satellite System) receiver. GNSS receivers use signals from satellites to determine the location and position of the tractor, allowing it to navigate accurately and efficiently within a positional reference plane.

The vehicle may use GPS, GLONASS (Global Navigation Satellite System), Galileo, or other satellite systems. These satellite systems provide signals that can be received by the location sensor 420 on the vehicle, allowing it to calculate its position and velocity in real-time.

The GNSS receiver (e.g., the location sensor 420) on the vehicle communicates with the satellite 426 by receiving signals from multiple satellites in orbit. The location sensor 420 uses these signals to determine its position relative to the satellite 426 and then calculates its position on the ground using this information. The location sensor 420 may also communicate with the satellite 426 to receive correction signals, which can improve the accuracy of the positioning data.

In addition to using GNSS receivers, the location sensor 420 can also communicate with satellite 426 using other communication technologies such as satellite-based internet services. These technologies may provide reliable communication links between the location sensor 420 and other devices, allowing for remote monitoring and control of other vehicle activities.

The controller 402 may also transmit instructions to the vehicle control system 430 to adjust parameters of the driveline, 450, the braking system 492, or the implement system 437. The controller 402 may transmit instructions associated with offset and location data as determined by the offset module 410 and as received by the location sensor 420. This may include adjusting a steering angle, a braking force, a differential lock position, a four-wheel drive engagement, an engine speed, a transmission gear setting, a power take-off speed, an implement depth or other action, or a vehicle ground speed, etc.

In some embodiments, the offset module 410, the navigation point database 432, the first positional reference model 436, the offset database 434, and the second positional reference model 438 are hosted remotely on a server 428. In this embodiment, all vehicles in the fleet of vehicles 460, regardless of manufacturer, may access the information stored therein. In this way, one vehicle may upload an offset or positional reference model, and all vehicles may access that data. Likewise, a vehicle may upload a navigation point to the navigation point database and all vehicles may have access to the navigation point and be able to translate the coordinates to a positional reference model used by each individual tractor.

The navigation point database 432 may include a list of navigation points. Navigation points may consist of a data type (e.g., boundaries, objects, guidelines, etc.) and corresponding coordinates in a positional reference model. The corresponding coordinates may comprise a first coordinate (e.g., an X coordinate) and a second coordinate (e.g., a Y coordinate). In some embodiments, the coordinate may include a third coordinate (e.g., a Z coordinate). Navigation points may be uploaded or downloaded to the navigation point database in a variety of methods. For example, the user may input through input device 412 a data type and corresponding coordinate by locating a point on a map. The user may also input the navigation point in real time, wherein the user uploads the current location of the vehicle with a corresponding data type.

In other embodiments, navigation points are automatically generated based on map data. For example, a user may use input device 412 and output device 414 to locate a tract of land on a map. In some embodiments, the processor may locate boundaries (such as rivers, cliffs, buildings, property or field boundaries) on the map by analyzing the map data and automatically generate data types and corresponding coordinates (through the use of offset module) to store in navigation point database 432. In other embodiments, the operator may define the navigation points on the map. In some embodiments, the offset module may analyze deed records to generate tract boundaries based on a landowner's property boundaries.

The first positional reference model 436 is a representative known positional reference model. Known datum and coordinates associated with the first positional reference model is stored in memory 408. This information may be used by offset module 410 to convert navigation points between the first positional reference model 436 and other positional reference models stored in memory 408 (e.g., second positional reference model 438). Second positional reference model 438 may be known or unknown. It should be understood that unknown positional reference models are positional reference models that use GNSS corrections having an unknown datum or coordinate reference frame. Known positional reference models are models that use GNSS corrections with a known datum or coordinate reference frame.

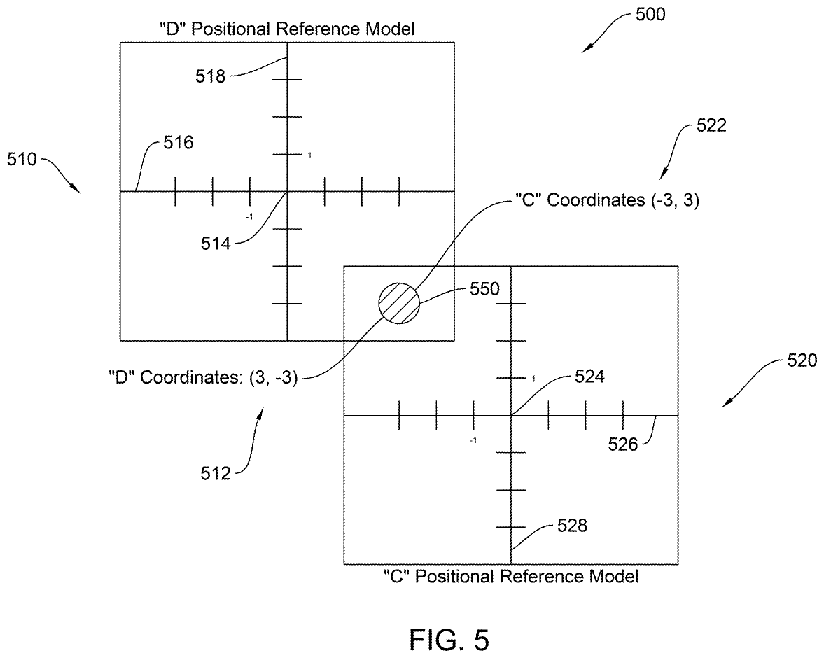

Referring now to FIG. 5, two positional reference models are shown as positional reference model overlay 500. Positional reference model overlay 500 includes a “D” positional reference model 510, a “C” positional reference model 520, a navigation point 550, a navigation point “D” coordinates, a navigation point “C” coordinates, a “D” positional reference model origin 514, a “C” positional reference model origin 524, a “D” positional reference model X-axis 516, a “C” positional reference model X-axis 526, a “D” positional reference model Y-axis 518, and a “C” positional reference model Y-axis 528.

As can be seen in FIG. 5, a single data type for a given on-ground position may have different coordinates based on which positional reference model is used. For example, the navigation point 550 has a “D” coordinates 512 of (3,−3), however, the navigation point 550 has a “C” coordinates of (−3,3).

This dissonance of coordinates can have detrimental results if a vehicle utilizing the “C” positional reference model uses navigation points with coordinates from the “D” positional reference model. For example, if an operator of a tractor using the “C” positional reference model inputs the navigation point with coordinates (3,−3) because the navigation point was uploaded by a second user using a tractor using the “D” positional reference model, the operator would be offset from the ground position of the navigation point by (−6,−6).

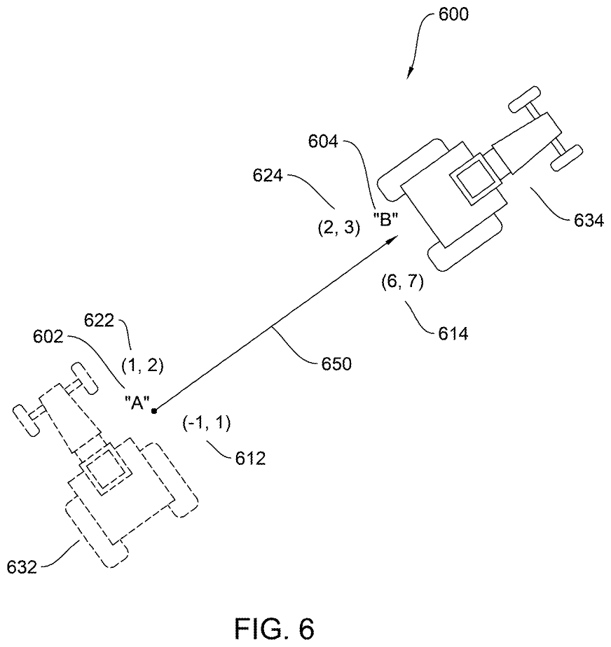

Referring now to FIG. 6, a calibration process 600 is shown. Calibration process 600 includes a starting ground location “A” 602, a first positional reference model coordinates for “A” 622, a second positional reference model coordinates for “A” 612, an ending ground location “B” 604, a first positional reference model coordinates for “B” 624, a second positional reference model coordinates for “B” 614, a vehicle 634, a starting location 632 of vehicle 634, and a path 650.

Calibration process 600 is used to determine an offset between a first positional reference model and second positional reference model. Using the vehicle 634 (utilizing a first positional reference model), an operator drives the vehicle 634 to the starting ground location “A” 602 represented by a navigation point, the navigation point (and associated coordinates) associated with a second positional reference model. Once at the starting ground location “A” 612, the operator records (in the first positional reference model) a set of coordinates 622 of the vehicle's current position (i.e., the starting ground position “A” 602 of the navigation point), the recorded set of coordinates 622 being associated with the first positional reference model and stored in a database, such as navigation point database 432 of FIG. 4. At this point, the operator knows the coordinates of the specific starting ground location “A” 602 in both the first positional reference model (the first positional reference model coordinates for “A” 622) and the second positional reference model (the second positional reference model coordinates for “A” 612).

The operator then moves the vehicle 634 along path 650 to the ending ground location “B” 604, represented by a second navigation point, the second navigation point (and associated coordinates) associated with the second positional reference model. In some embodiments, the vehicle 634 turns 90° from the heading direction of the vehicle 634 at the starting ground location “A” 602 (shown as previous position 632) before travelling to ending ground location “B” 604. Once at the ending ground location “B” 604, the operator records (in the first positional reference model) a second set of coordinates 624 of the vehicle's current position (i.e., the ending ground position “B” of the second navigation point), the second recorded set of coordinates 624 being associated with the first positional reference model and stored in the database, such as navigation point database 432 of FIG. 4. At this point, the operator knows the coordinates of the specific ending ground location “B” 604 in both the first positional reference model (the first positional reference model coordinates for “B” 624) and the second positional reference model (the second positional reference model coordinates for “B” 614).

Now knowing the coordinates of two ground locations 602, 604 in both the first positional reference model and the second positional reference model, the system may determine an offset in an X and Y datum (the X and Y being orthogonal) between the first positional reference model and the second positional reference model by determining, by the offset module 410 of FIG. 4, the offset needed to translate between the two positional reference models. With this resultant offset, the system may convert coordinates of navigation points between the two positional reference models, whether known or unknown. It should be appreciated, that this method may be used in any combination of positional reference models: known and known, known and unknown, or unknown and unknown.

In an exemplary embodiments, the process may also be further calibrated by repeating this process 3 more times in substantially orthogonal directions (e.g., rotating approximately 90 degrees, traveling straight and again comparing the ending coordinates in both the first and second positional reference model).

This offset is stored, and when enabled, the GNSS system will apply the position offsets to the GNSS position being used for guidance, mapping, and other features on the fly so that the vehicle's on-ground position will be physically moved according to the desired offset. Any data saved or output from the system may also include this position offset, including visual and recorded data for map, as-applied, GNSS position data (such as that which is consumed internally and/or output to 3rd party devices or systems), etc. This allows the on-board and off-board data to match that of the other systems in the fleet that operate on a different positional reference model. This system and method may be used for any number of vehicles and positional reference models.

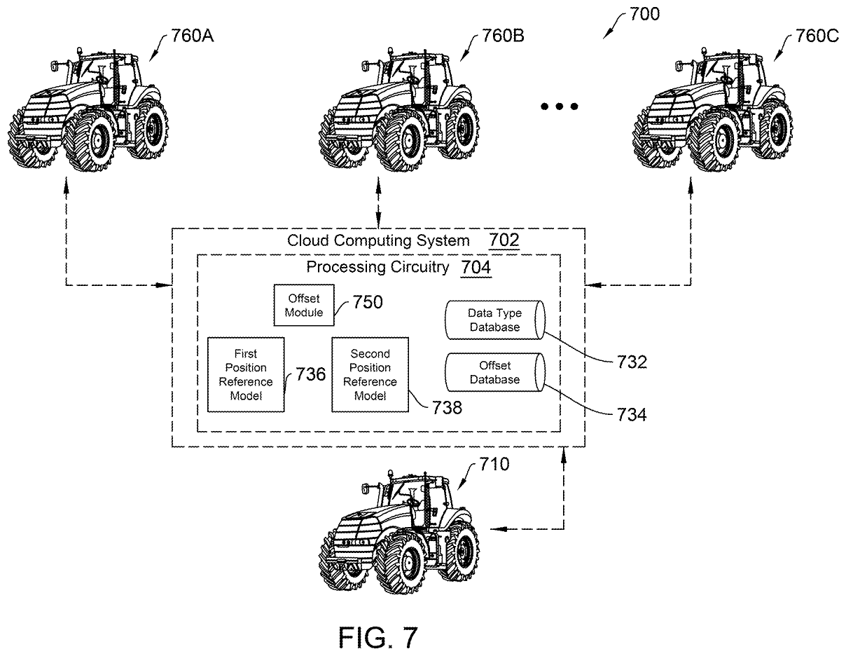

Referring now to FIG. 7, a fleet network 700 of vehicles 710, 760A-N is shown. In this embodiment, the vehicles 710, 760A-N are communicably coupled through a cloud computing system 702. Cloud computing system 702 may be hosted on a server connected to a network to which the vehicles 710, 760A-N are communicably coupled. In some embodiments, the cloud computing system 702 includes a processing circuitry 704 which includes a navigation point database 732, a first positional reference model 736, an offset database 734, a second positional reference model 738, and an offset model 750. The processing circuitry 704 constituent components operate in substantially the same manner as disclosed in FIG. 4. In this embodiment, any vehicle 710, 760A-N may upload a navigation point (in whatever positional reference model used by the vehicle 710, 760A-N) to be stored in the navigation point database 732. By uploading the navigation point, each vehicle in the fleet may access the navigation point. If a vehicle 710, 760A-N using a different positional reference model than that used by the uploading vehicle, the offset model 750 may convert the uploaded navigation point to have coordinates in the different positional reference model. In some embodiments, the offset model 750 converts all navigation points to the appropriate positional reference model when a vehicle accesses the navigation point.

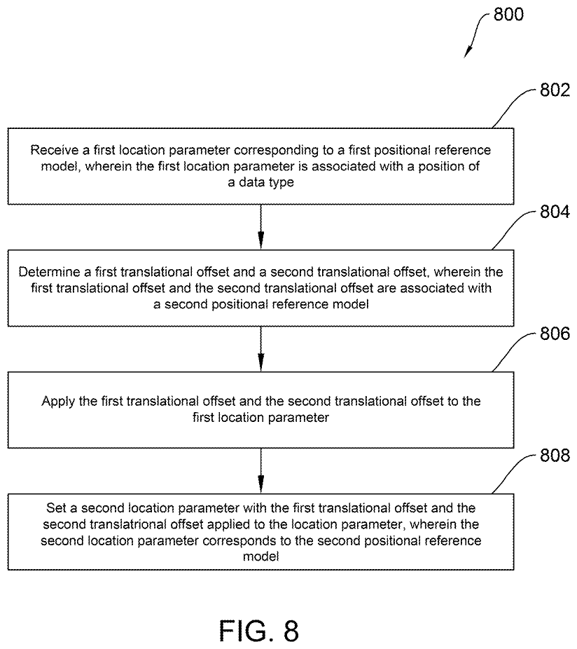

FIG. 8 is a flowchart of an example process 800. In some implementations, one or more process blocks of FIG. 8 may be performed by an apparatus or system as disclosed in the present disclosure.

As shown in FIG. 8, process 800 may include receiving, by a processor, a first location parameter corresponding to a first positional reference model, where the first location parameter is associated with a position of a data type (step 802). For example, the offset control system may receive, by a processor, a first location parameter corresponding to a first positional reference model, where the first location parameter is associated with a position of a data type, as described above. As also shown in FIG. 8, process 800 may include determining, by the processor, a first translational offset and a second translational offset, where the first translational offset and the second translational offset are associated with a second positional reference model (step 804). For example, the offset control system may determine, by the processor, a first translational offset and a second translational offset, where the first translational offset and the second translational offset are associated with a second positional reference model, as described above. As further shown in FIG. 8, process 800 may include applying, by the processor, the first translational offset and the second translational offset to the first location parameter (step 806). For example, the offset control system may apply, by the processor, the first translational offset and the second translational offset to the first location parameter, as described above. As also shown in FIG. 8, process 800 may include setting, by the processor, a second location parameter with the first translational offset and the second translational offset applied to the first location parameter, where the second location parameter corresponds to the second positional reference model (step 808). For example, the offset control system may set, by the processor, a second location parameter with the first translational offset and the second translational offset applied to the first location parameter, where the second location parameter corresponds to the second positional reference model, as described above.

In some embodiments, the first location parameter is a coordinate. In some embodiments, the first location parameter is a plurality of coordinates. In some embodiments, the second location parameter is a coordinate. In some embodiments, the second location parameter is a plurality of coordinates. In some embodiments, the first and second location parameters are a time. In some embodiments, the first translational offset is in the X direction and the second translational offset is in the Y direction.

In some embodiments, the offset module of FIG. 4 applies the translational offsets to the first location parameters. The processor 406 then sets the second location in the memory, specifically the navigation point database 432 of FIG. 4.

Process 800 may include additional implementations, such as any single implementation or any combination of implementations described below and/or in connection with one or more other processes described elsewhere herein. In a first implementation, the first location parameter is a coordinate value for the data type.

In a second implementation, alone or in combination with the first implementation, the first positional reference model is a datum of a global navigation satellite system (GNSS) correction model.

In a third implementation, alone or in combination with the first and second implementation, the data type is one of a guidance line, a boundary, or an obstacle.

In a fourth implementation, alone or in combination with one or more of the first through third implementations, the first translational offset is associated with an East/West correction and the second the second translational offset is associated with a North/South correction.

A fifth implementation, alone or in combination with one or more of the first through fourth implementations, process 800 may include applying a third translational offset and a fourth translational offset to the second location parameter.

Although FIG. 8 shows example steps of process 800, in some implementations, process 800 may include additional steps, fewer steps, different steps, or differently arranged steps than those depicted in FIG. 8. Additionally, or alternatively, two or more of the steps of process 800 may be performed in parallel.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a vehicle, a Global Positioning System (GPS) receiver, etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user. Other kinds of devices may be used to provide for interaction with a user as well; for example, feedback provided to the user may be any form of sensory feedback (e.g., visual feedback, auditory feedback, or tactile feedback).

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

It is important to note that the construction and arrangement of the vehicle 10 and the systems and components thereof (e.g., the driveline 50, the braking system 100, the control system 200, etc.) as shown in the various exemplary embodiments is illustrative only. Additionally, any element disclosed in one embodiment may be incorporated or utilized with any other embodiment disclosed herein.

1. A system comprising:
an agricultural vehicle; and
a control system comprising processing circuitry configured to:
receive a first location parameter corresponding to a first positional reference model, wherein the first location parameter is associated with a position of a data type;
determine a first translational offset and a second translational offset, wherein the first translational offset and the second translational offset are associated with a second positional reference model;
apply the first translational offset and the second translational offset to the first location parameter;
set a second location parameter with the first translational offset and the second translational offset applied to the first location parameter, wherein the second location parameter corresponds to the second positional reference model.

2. The system of claim 1, wherein the first location parameter is a coordinate value for the data type.

3. The system of claim 1, wherein the first positional reference model is a datum of a global navigation satellite system (GNSS) correction model.

4. The system of claim 1, wherein the data type is one of a guidance line, a boundary, or an obstacle.

5. The system of claim 1, wherein the first translational offset is associated with an East/West correction and the second the second translational offset is associated with a North/South correction.

6. The system of claim 1, wherein the control system is further configured to apply a third translational offset and a fourth translational offset to the second location parameter.

7. The system of claim 1, wherein the agricultural vehicle is one of a plurality of agricultural vehicles in a fleet, wherein the plurality of agricultural vehicles have access to the second location parameter.

8. A control system comprising processing circuitry configured to:
receive a first location parameter corresponding to a first positional reference model, wherein the first location parameter is associated with a position of a data type;
determine a first translational offset and a second translational offset, wherein the first translational offset and the second translational offset are associated with a second positional reference model;
apply the first translational offset and the second translational offset to the first location parameter; and
set a second location parameter with the first translational offset and the second translational offset applied to the first location parameter, wherein the second location parameter corresponds to the second positional reference model.

9. The control system of claim 8, wherein the first location parameter is a coordinate value for the data type.

10. The control system of claim 8, wherein the first positional reference model is a datum of a global navigation satellite system (GNSS) correction model.

11. The control system of claim 8, wherein the data type is one of a guidance line, a boundary, or an obstacle.

12. The control system of claim 8, wherein the first translational offset is associated with an East/West correction and the second the second translational offset is associated with a North/South correction.

13. The control system of claim 8, wherein the control system is further configured to apply a third translational offset and a fourth translational offset to the second location parameter.

14. The control system of claim 8, wherein the control system is associated with an agricultural vehicle, wherein the agricultural vehicle is one of a plurality of agricultural vehicles in a fleet, wherein the plurality of agricultural vehicles have access to the second location parameter.

15. A method comprising:
receiving, by a processor, a first location parameter corresponding to a first positional reference model, wherein the first location parameter is associated with a position of a data type;
determining, by the processor, a first translational offset and a second translational offset, wherein the first translational offset and the second translational offset are associated with a second positional reference model;
applying, by the processor, the first translational offset and the second translational offset to the first location parameter; and
setting, by the processor, a second location parameter with the first translational offset and the second translational offset applied to the first location parameter, wherein the second location parameter corresponds to the second positional reference model.

16. The method of claim 15, wherein the first location parameter is a coordinate value for the data type.

17. The method of claim 15, wherein the first positional reference model is a datum of a global navigation satellite system (GNSS) correction model.

18. The method of claim 15, wherein the data type is one of a guidance line, a boundary, or an obstacle.

19. The method of claim 15, wherein the first translational offset is associated with an East/West correction and the second the second translational offset is associated with a North/South correction.

20. The method of claim 15, further comprising applying a third translational offset and a fourth translational offset to the second location parameter.
